(19) United States
(12) Patent Application Publication
(10) Pub. No.: US 2015/0137456 A1
(43) Pub. Date: May 21, 2015

(54) Packer for Cable Gland and Use of the Same

(71) Applicant: Tranberg AS, Stavanger (NO)

(72) Inventor: Asbjorn Lund, Stavanger (NO)

(73) Assignee: Tranberg AS, Stavanger (NO)

(21) Appl. No.: 14/408,149

(22) PCT Filed: Jun. 19, 2013
(86) PCT No.: PCT/NO2013/050110

§ 371 Date: Dec. 15, 2014

(30) Foreign Application Priority Data
Jun. 22, 2012 (NO) 20120727

(51) Int. Cl. F16J 15/02; H02G 15/00

(52) U.S. Cl. CPC F16J 15/022; H02G 15/003
USPC 277/314; 277/627

(57) ABSTRACT

A packer is for use in a cable gland. The packer is formed from an elastic material including coarse-grained particles of a hardness sufficient for engagement with the surface of a cable, which has been inserted into the cable gland, when pressure is applied around the packer, whereby the packer substantially prevents the cable from slipping in the cable gland. A packer is used together with a cable gland.

### CROSS-REFERENCE TO RELATED APPLICATIONS

This application is the U.S. national stage application of International Application PCT/NO2013/050110, filed Jun. 19, 2013, which international application was published on Dec. 27, 2013, as International Publication WO2013/191562 in the English language. The international application is incorporated herein by reference, in entirety. The international application claims priority to Norwegian Patent Application No. 20120727, filed Jun. 22, 2012, which is incorporated herein by reference, in entirety.

### FIELD

The invention relates to a packer. More specifically, the invention relates to a packer for use in cable glands to prevent a cable or wire from slipping in the cable gland. The invention also relates to an application of a packer in accordance with the invention in a cable gland.

### BACKGROUND

A cable gland has, in the main, two functions; it is to seal around a cable, for example with respect to gas, dust particles and moisture, and it is to retain the cable so that the cable is locked mechanically in position. The cable gland is provided with an internal packer which is clamped around the surface of the cable to try to achieve the two functions mentioned. It has turned out to be difficult to satisfy a requirement for holding a cable in position by means of prior-art cable glands. This results from the cable more often than not being provided with a smooth surface while, at the same time, said internal packer in the cable gland is provided from an elastic material, often silicone or synthetic rubber. The friction between the packer and the cable will thereby be low and it will be difficult to prevent the cable from slipping in the cable gland. Producers have been directed to mark a cable gland with an “X” to indicate that the requirement for mechanical locking is not met.

The patent document DE 4208356 C1 describes how twisting of a cable gland when being attached in a cabinet can be prevented. This is done by installing a friction ring between the cable gland and the cabinet. The result is that an insert may better be screwed into the cable gland, whereby an internal packer in the cable gland will better seal around and better fix a cable extending through the cable gland.

The patent document WO 2007/134212 A1 discloses a cabinet for telecommunication cables to pass through, the cabinet containing a cable-holding device. A cable is held either by a flexible abrasive material being provided between a cable clamp and the cable sheath or by an internal surface of the cable damp being formed with sharp protrusions.

### SUMMARY

The invention has for its object to remedy or reduce at least one of the drawbacks of the prior art or at least provide a useful alternative to the prior art.

The object is achieved through features which are specified in the description below and in the claims that follow.

By a cable is meant, in what follows, all types of cables and wires of types known per Se.

In a first aspect, the invention relates to a packer for use in a cable gland, the packer being characterized by being formed from an elastic, expandable material with an admixture of coarse-grained particles of a hardness that is sufficient for engagement with the surface of a cable, which has been inserted in the cable gland, when pressure is applied to the packer, whereby the packer substantially prevents the cable from slipping in the cable gland.

Different cables may be provided with surfaces consisting of different materials and it may therefore be appropriate to use coarse-grained particles of different materials for different cables. Nevertheless, standardized test conditions in the trade require specification tests to be carried out on steel shafts. Materials of sufficient hardness may be, for example, but are not limited to materials that include: aluminium oxide, silicon carbide/carborundum, corundum (Al₃O₃ with traces of Fe, Ti and Cr), silicon nitride, carbon nitride, boron nitride (for example CBN and PCBN), tungsten carbide, synthetic diamond, various borides, nitrides, carbides and oxides, and combinations thereof.

The coarse-grained particles may be provided in different sizes. In one embodiment, the coarse-grained particles in the packer may have a size in the interval of 0.05 mm to 0.5 mm. This could be sufficiently large for the particles to engage with the surface of the cable while, at the same time, the packer is still sealing properly between the cable gland and the cable.

The present applicant has done successful tests on cable glands with packers with coarse-grained particles of a size in the interval of 0.07 mm to 0.23 mm. The coarse-grained particles were added to the elastic material during the moulding process in amounts equivalent to 40-60 per cent by weight. It could be about 50 per cent by weight, for example. In alternative embodiments, the coarse-grained particles may be added in amounts equivalent to 10-70 per cent by weight.

In an alternative embodiment, the coarse-grained particles are added only to some portions of the packer. That may be, for example, the inner surface which is resting against a cable in a situation of application.

In one embodiment, the elastic material may comprise silicone rubber. This will have the advantage of enabling the same type of packers to be used in many different areas of application as silicone rubber can withstand temperatures from −100 to 250° C., in addition to being very resistant to chemicals and ageing. In other embodiments, the elastic material may include different types of elastomers and other known, elastic materials, and combinations thereof.

In a second aspect, the invention relates to the use of a packer in accordance with the above description in a cable gland.

A cable gland including a packer in accordance with the above description is described as well.

A cable gland may utilize several different packers, or more of which may be of the type that is described above.

### BRIEF DESCRIPTION OF THE DRAWINGS

In what follows, an example of a preferred embodiment is described, which has been visualized in the accompanying drawings, in which:

FIG. 1 shows, in a front view, a packer in accordance with the present invention;

FIG. 2 shows, in perspective, a cable gland as used in the present invention;

FIG. 3 shows the cable gland of FIG. 2, in a side view; and

FIG. 4 shows a section through the cable gland of FIG. 3, viewed through the line A-A.

### DETAILED DESCRIPTION OF THE DRAWINGS

In what follows, the reference numeral 1 indicates a packer in accordance with the present invention.

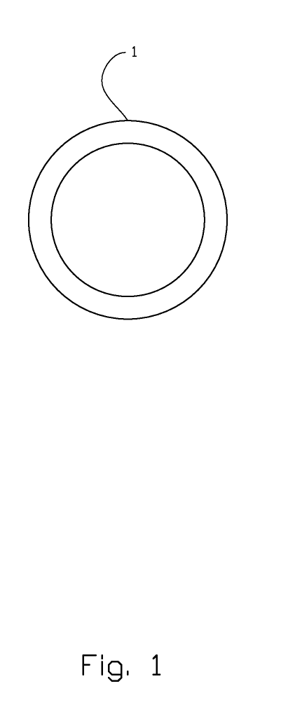

FIG. 1 shows a packer 1 in accordance with the present invention freed from components that that will lie around the packer 1 in the position of application.

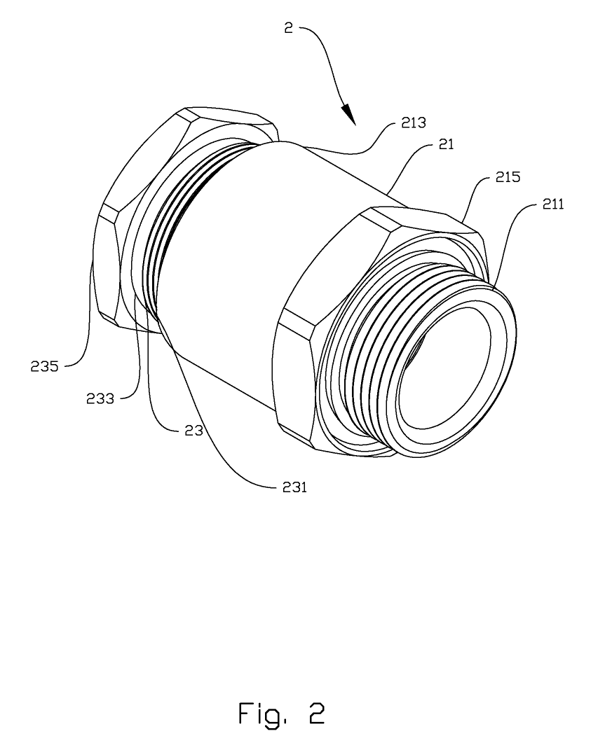

FIG. 2 shows a cable gland 2 as used together with a packer 1 in accordance with the present invention. In a position of application, the packer 1 will lie inside the cable gland 2 and is not shown in the figure. The cable gland consists of two parts screwed together; an adapter socket 21 and an insert 23. The adapter socket 21 consists of a nipple 211 at a first end and a sleeve 213 at a second end. The nipple 211 is formed with external threads, whereas the sleeve 213 is formed with internal threads. Between the nipple 211 and the sleeve 213, the adapter socket 21 is provided with a grip portion 215. At a first end 231, the insert 23 is formed with external threads, whereas a second end 233 is provided with a grip portion 235. The external threads at the first end 231 of the insert 23 complementarily fit the internal threads of the sleeve 213, whereby the insert 23 can be screwed into the adapter socket 21 to put axial pressure on a packer 1, which is not shown in this figure, to seal around and fix a cable, not shown.

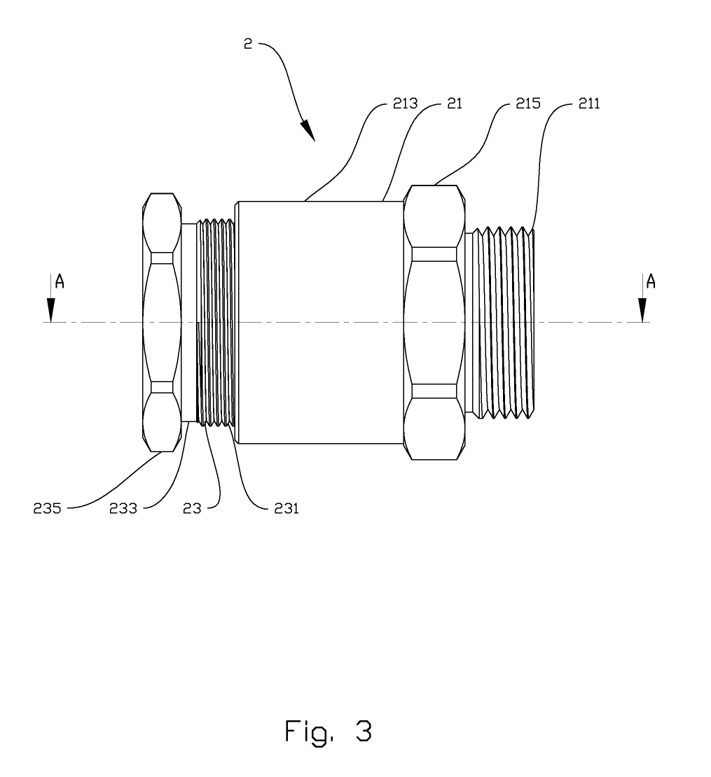

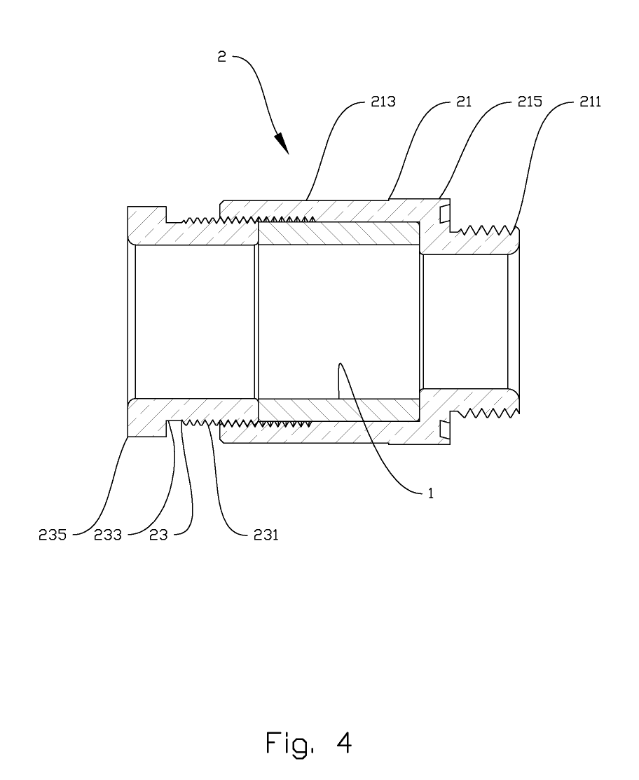

FIG. 3 shows the same cable gland 2 as FIG. 2, seen from the side here, whereas FIG. 4 shows a section through the cable gland 2 of FIG. 2, seen through the line A-A. In FIG. 4, the internal packer 1 is shown as well. As the insert 23 is screwed into the adapter socket 21, the packer 1 is compressed axially, whereby the packer 1 expands radially, as the packer 1 is formed of an elastic material, so that the space between a cable, not shown, and the cable gland 2 is sealed. By the elastic material also including coarse-grained, relatively hard particles, the cable will also be held sufficiently fixed in the cable gland 2.

1. A packer for use in a cable gland, wherein the packer is formed from an elastic, expandable material with an admixture of coarse-grained particles of a hardness sufficient for engagement with the surface of a cable, which has been inserted in the cable gland, when pressure is applied to the packer, whereby the packer substantially prevents the cable from slipping in the cable gland.

2. The packer in accordance with claim 1, wherein the coarse-grained particles comprise aluminium oxide (Al₂O₃).

3. The packer in accordance with claim 1, wherein the coarse-grained particles include silicon carbide (SiC).

4. The packer in accordance with claim 1, wherein the coarse-grained panicles have a size in the interval of 0.05 mm to 0.5 mm.

5. The packer in accordance with claim 4, wherein the coarse-grained particles have a size in the interval of 0.07 mm to 0.23 mm.

6. The packer in accordance with claim 1, wherein the elastic material comprises silicone rubber.

7. The packer in accordance with claim 1, wherein the elastic material has an admixture of coarse-grained particles in an amount equivalent to 40-60 per cent by weight.

8. A method comprising using a packer in a cable gland, wherein the packer is formed from an elastic, expandable material with an admixture of coarse-grained particles of a hardness sufficient for engagement with the surface of a cable, which has been inserted in the cable gland, when pressure is applied to the packer, whereby the packer substantially prevents the cable from slipping in the cable eland.

9. A cable eland comprising an inner packer, wherein the packer is formed from an elastic, expandable material with an admixture of coarse-grained particles of a hardness sufficient for engagement with the surface of a cable, which has been inserted in the cable gland, when pressure is applied to the packer, whereby the packer substantially prevents the cable from slipping in the cable gland.
